(19) United States
(12) Patent Application Publication
(10) Pub. No.: US 2024/0067303 A1
(43) Pub. Date: Feb. 29, 2024

(54) TRANSMISSION FOR ELECTRIC SNOWMOBILE

(71) Applicant: TAIGA MOTORS INC., Lasalle (CA)

(72) Inventors: Matthew Schroeder, Montreal (CA); Cyrille Goldstein, Montreal (CA); Amin Zabihinejad, Montreal (CA); Samuel Bruneau, Montreal (CA); Paul Achard, Montreal (CA)

(21) Appl. No.: 17/822,497

(22) Filed: Aug. 26, 2022

(51) Int. Cl. B62M 27/02

(52) U.S. Cl. CPC B62M 27/02; B62K 2204/00

(57) ABSTRACT

An electric snowmobile, has: a frame; a drive track assembly having a drive track and a sprocket; an electric motor mounted to the frame; and a transmission mounted to the frame, the transmission drivingly engaging the electric motor to the drive track, the transmission having an input drivingly engaged by the electric motor and an output drivingly engaging the sprocket, the transmission having a speed ratio defined as a rotational speed of the input to a rotational speed of the output, and wherein one or more of: a rotor-to-sprocket ratio ranging from 0.65 to 1.30, a rotor-to-transmission ratio ranging from 52 mm to 180 mm, a stator-to-sprocket ratio ranging from 0.20 to 0.58, and a rotor size-to-sprocket ratio ranging from 25 mm to 105 mm.

### TECHNICAL FIELD

The application relates generally to snowmobiles and, more particularly, to electrically-powered snowmobiles.

### BACKGROUND

Some snowmobiles combust fuel in an internal-combustion engine. The architecture of such fuel-consuming snowmobiles is designed to accommodate the size, weight and loads generated by the internal-combustion engine during operation of the snowmobile. The architecture of such fuel-consuming snowmobiles is also designed to accommodate the evacuation of hot combustion gases, cooling of components, and the lubrication of still other components.

For snowmobiles having batteries which supply electrical power to one or more electric motors, the architecture of the snowmobile may be different than that of fuel-consuming snowmobiles.

### SUMMARY

In one aspect, there is provided an electric snowmobile, comprising: a frame extending along a longitudinal axis between a front end and a rear end of the frame; a drive track assembly having a drive track for engaging a ground and a sprocket rollingly engaged to the frame and meshed with the drive track; an electric motor mounted to the frame; and a transmission mounted to the frame, the transmission drivingly engaging the electric motor to the drive track, the transmission having an input drivingly engaged by the electric motor and an output drivingly engaging the sprocket, the transmission having a speed ratio defined as a rotational speed of the input to a rotational speed of the output, and wherein one or more of: a rotor-to-sprocket ratio of a rotor diameter of a rotor of the electric motor to a sprocket diameter of the sprocket ranges from 0.65 to 1.30, a rotor-to-transmission ratio of the rotor diameter to the speed ratio of the transmission ranges from 52 mm to 180 mm, a stator-to-sprocket ratio of a length of a stator of the electric motor to the sprocket diameter ranges from 0.20 to 0.58, and a rotor size-to-sprocket ratio of a product of the rotor diameter by the length of the stator to the sprocket diameter ranges from 25 mm to 105 mm.

The electric snowmobile described above may include any of the following features, in any combinations.

In some embodiments, the rotor-to-sprocket ratio ranges from 0.65 to 1.30 and the rotor-to-transmission ratio ranges from 52 mm to 180 mm.

In some embodiments, the rotor-to-sprocket ratio ranges from 0.65 to 1.30 and the stator-to-sprocket ratio ranges from 0.20 to 0.58.

In some embodiments, the rotor-to-sprocket ratio ranges from 0.65 to 1.30 and the rotor size-to-sprocket ratio ranges from 25 mm to 105 mm.

In some embodiments, the rotor-to-transmission ratio ranges from 52 mm to 180 mm and the stator-to-sprocket ratio ranges from 0.20 to 0.58.

In some embodiments, the rotor-to-transmission ratio ranges from 52 mm to 180 mm and the rotor size-to-sprocket ratio ranges from 25 mm to 105 mm.

In some embodiments, the stator-to-sprocket ratio ranges from 0.20 to 0.58 and the rotor size-to-sprocket ratio ranges from 25 mm to 105 mm.

In some embodiments, the rotor-to-sprocket ratio ranges from 0.70 to 1.23.

In some embodiments, the rotor-to-sprocket ratio is about 0.85.

In some embodiments, the rotor-to-transmission ratio ranges from 56 to 170.

In some embodiments, the rotor-to-transmission ratio is about 66.

In some embodiments, the stator-to-sprocket ratio ranges from 0.23 to 0.51.

In some embodiments, the stator-to-sprocket ratio is about 0.30.

In some embodiments, the rotor size-to-sprocket ratio ranges from 31 mm to 87 mm.

In some embodiments, the rotor size-to-sprocket ratio is about 46 mm.

In some embodiments, the speed ratio is about 2.375.

In some embodiments, the frame includes a sub-frame and a tunnel secured to the sub-frame, the electric motor mounted to the sub-frame, a battery pack extending over the tunnel and at least partially overlapping the electric motor.

In some embodiments, the battery pack at least partially overlaps the transmission.

In another aspect, there is provided an electric snowmobile, comprising: a frame extending along a longitudinal axis between a front end and a rear end of the frame; a drive track assembly having a drive track for engaging a ground and a sprocket rollingly engaged to the frame and meshed with the drive track; an electric motor mounted to the frame; and a transmission mounted to the frame, the transmission drivingly engaging the electric motor to the drive track, the transmission having a drive wheel engaged to the electric motor and a driven wheel engaged to the drive wheel and engaging the sprocket, the transmission having a speed ratio defined as a driven diameter of the driven wheel to a drive diameter of the drive wheel, and wherein one or more of: a rotor-to-sprocket ratio of a rotor diameter of a rotor of the electric motor to a sprocket diameter of the sprocket ranges from 0.65 to 1.30, a rotor-to-transmission ratio of the rotor diameter to the speed ratio of the transmission ranges from 52 mm to 180 mm, a stator-to-sprocket ratio of a length of a stator of the electric motor to the sprocket diameter ranges from 0.20 to 0.58, a rotor size-to-sprocket ratio of a volume of the rotor to the sprocket diameter ranges from 25 mm to 105 mm, and a rotor-to-driven-and-sprocket ratio of the rotor diameter divided by a ratio of the driven diameter to the sprocket diameter ranges from 166 mm to 231 mm.

The electric snowmobile described above may include any of the following features, in any combinations.

In some embodiments, the rotor-to-sprocket ratio ranges from 0.65 to 1.30 and the rotor-to-transmission ratio ranges from 52 mm to 180 mm.

In some embodiments, the rotor-to-sprocket ratio ranges from 0.65 to 1.30 and the stator-to-sprocket ratio ranges from 0.20 to 0.58.

In some embodiments, the rotor-to-sprocket ratio ranges from 0.65 to 1.30 and the rotor size-to-sprocket ratio ranges from 25 mm to 105 mm.

In some embodiments, the rotor-to-sprocket ratio ranges from 0.65 to 1.30 and the rotor-to-driven-and-sprocket ratio ranges from 166 mm to 231 mmm.

In some embodiments, the rotor-to-transmission ratio ranges from 52 mm to 180 mm and the stator-to-sprocket ratio ranges from 0.20 to 0.58.

In some embodiments, the rotor-to-transmission ratio ranges from 52 mm to 180 mm and the rotor size-to-sprocket ratio ranges from 25 mm to 105 mm.

In some embodiments, the rotor-to-transmission ratio ranges from 52 mm to 180 mm and the rotor-to-driven-and-sprocket ratio ranges from 166 mm to 231 mm.

In some embodiments, the stator-to-sprocket ratio ranges from 0.20 to 0.58 and the rotor size-to-sprocket ratio ranges from 25 mm to 105 mm.

In some embodiments, the stator-to-sprocket ratio ranges from 0.20 to 0.58 and the rotor-to-driven-and-sprocket ratio ranges from 166 mm to 231 mm.

In some embodiments, the rotor size-to-sprocket ratio ranges from 25 mm to 105 mm and the rotor-to-driven-and-sprocket ratio ranges from 166 mm to 231 mm.

In some embodiments, the rotor-to-sprocket ratio ranges from 0.70 to 1.23.

In some embodiments, the rotor-to-sprocket ratio is about 0.85.

In some embodiments, the rotor-to-transmission ratio ranges from 56 to 170.

In some embodiments, the rotor-to-transmission ratio is about 66.

In some embodiments, the stator-to-sprocket ratio ranges from 0.23 to 0.51.

In some embodiments, the stator-to-sprocket ratio is about 0.30.

In some embodiments, the rotor size-to-sprocket ratio ranges from 31 mm to 87 mm.

In some embodiments, the rotor size-to-sprocket ratio is about 46 mm.

In some embodiments, the rotor-to-driven-and-sprocket ratio ranges from 179 mm to 218 mm.

In some embodiments, the rotor-to-driven-and-sprocket ratio is about 201 mm.

In some embodiments, the speed ratio is about 2.375.

In some embodiments, the frame includes a sub-frame and a tunnel secured to the sub-frame, the electric motor mounted to the sub-frame, a battery pack extending over the tunnel and at least partially overlapping the electric motor.

In some embodiments, the battery pack at least partially overlaps the transmission.

In yet another aspect, there is provided an electric snowmobile, comprising: a frame extending along a longitudinal axis between a front end and a rear end of the frame; a drive track assembly having a drive track for engaging a ground and a sprocket rollingly engaged to the frame and meshed with the drive track; an electric motor mounted to the frame; and a transmission mounted to the frame, the transmission drivingly engaging the electric motor to the drive track, the transmission having an input drivingly engaged by the electric motor and an output drivingly engaging the sprocket, the transmission having a speed ratio defined as a rotational speed of the input to a rotational speed of the output, and wherein an overall value of a rotor diameter of a rotor of the electric motor multiplied by the speed ratio of the transmission multiplied by a sprocket diameter of the sprocket ranges from 17940 to 90000 mm².

The electric snowmobile described above may include any of the following features, in any combinations.

In some embodiments, the overall value is about 68982.

In some embodiments, rotor-to-sprocket ratio of the rotor diameter to the sprocket diameter ranges from 0.65 to 1.30.

In some embodiments, the rotor-to-sprocket ratio ranges from 0.70 to 1.23.

In some embodiments, the rotor-to-sprocket ratio is about 0.85.

In some embodiments, a rotor-to-transmission ratio of the rotor diameter to the speed ratio of the transmission ranges from 52 mm to 180 mm.

In some embodiments, the rotor-to-transmission ratio ranges from 56 to 170.

In some embodiments, the rotor-to-transmission ratio is about 66.

In some embodiments, a stator-to-sprocket ratio of a length of a stator of the electric motor to the sprocket diameter ranges from 0.20 to 0.58.

In some embodiments, the stator-to-sprocket ratio ranges from 0.23 to 0.51.

In some embodiments, the stator-to-sprocket ratio is about 0.30.

In some embodiments, a rotor size-to-sprocket ratio of a volume of the rotor to the sprocket diameter ranges from 25 mm to 105 mm.

In some embodiments, the rotor size-to-sprocket ratio ranges from 31 mm to 87 mm.

In some embodiments, the rotor size-to-sprocket ratio is about 46 mm.

In some embodiments, the transmission has a drive wheel engaged to the electric motor and a driven wheel engaged to the drive wheel and engaging the sprocket.

In some embodiments, a rotor-to-driven-and-sprocket ratio of the rotor diameter divided by a ratio of a driven diameter of the driven wheel to the sprocket diameter ranges from 166 mm to 231 mm.

In some embodiments, the rotor-to-driven-and-sprocket ratio ranges from 179 mm to 218 mmm.

In some embodiments, the rotor-to-driven-and-sprocket ratio is about 201 mm.

In some embodiments, the speed ratio is about 2.375.

In some embodiments, the frame includes a sub-frame and a tunnel secured to the sub-frame, the electric motor mounted to the sub-frame, a battery pack extending over the tunnel and at least partially overlapping the electric motor.

In some embodiments, the battery pack at least partially overlaps the transmission.

### BRIEF DESCRIPTION OF THE DRAWINGS

Reference is now made to the accompanying figures in which:

FIG. 1 is a schematic representation of an electric snowmobile;

FIG. 2 is a schematic representation of a mechanical connection between an electric motor of the snowmobile of FIG. 1 and a drive track of the snowmobile of FIG. 1;

FIG. 3 is an enlarged three dimensional view of a transmission of the electric snowmobile of FIG. 1;

FIG. 4 is a three dimensional view of the electric snowmobile of FIG. 1;

FIG. 5 is a front three dimensional view of a frame of the electric snowmobile of FIG. 4;

FIG. 6 is another front three dimensional view of the frame of the electric snowmobile of FIG. 3 with a battery pack secured thereto;

FIG. 7 is a side view of the frame and battery pack of the electric snowmobile of FIG. 4;

FIG. 8 is a three dimensional view of a transmission and drive train of the snowmobile of FIG. 3 with other components of the snowmobile removed for illustration purposes;

FIG. 9 is a front plan view of a rotor of an electric motor of the snowmobile of FIG. 1 in accordance with one embodiment;

FIG. 10 is a front plan view of a rotor of the electric motor of the snowmobile of FIG. 1 in accordance with another embodiment

FIG. 11 is a front plan view of a rotor and stator of the electric motor of the snowmobile of FIG. 1 in accordance with one embodiment; and

FIG. 12 is a front plan view of a rotor and stator of the electric motor of the snowmobile of FIG. 1 in accordance with another embodiment.

### DETAILED DESCRIPTION

The following disclosure relates to straddle seat vehicles and associated methods for operating the straddle seat vehicles. The straddle seat vehicles are drivingly engaged to motors for effecting propulsion of the vehicles in both forward and reverse directions. In some embodiments, the straddle seat vehicles and methods described herein may be applicable to electric powersport vehicles that may be operated off-road and/or in relatively rugged environments. Examples of suitable off-road electric and non-electric powersport vehicles include snowmobiles, all-terrain vehicles (ATVs), and utility task vehicles (UTVs) (e.g. side-by-sides). As used herein, the term off-road vehicle refers to vehicles to which at least some regulations, requirements or laws applicable to on-road vehicles do not apply. In some embodiments, the vehicles and methods described herein may, based on one or more positions of an input device operatively connected to a motor, determine the forward direction and reverse direction of propulsion for the vehicle.

The terms “connected”, “connects” and “coupled to” may include both direct connection and coupling (in which two elements contact each other) and indirect connection and coupling (in which at least one additional element is located between the two elements).

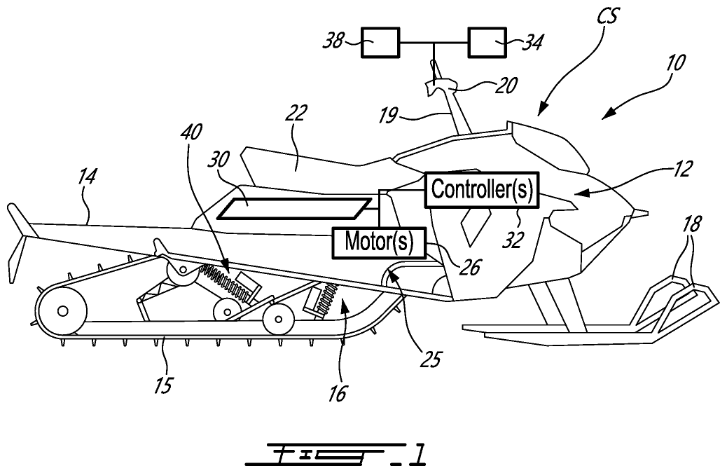

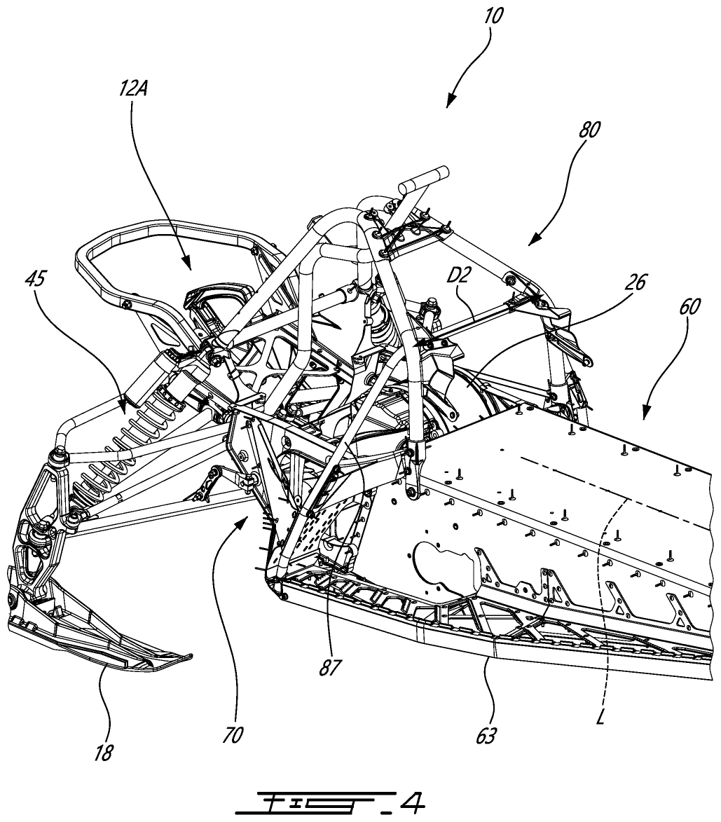

With reference to FIG. 1, an electric snowmobile in accordance with one embodiment is shown at 10. The electric snowmobile 10 may include a frame 12 (also known as a body or a chassis) which may include a tunnel 14, a drive track 15 having the form of an endless belt for engaging the ground (e.g., snow) and disposed under the tunnel 14, and a powertrain 16 mounted to the frame 12 and configured to displace the drive track 15. Skis 18 are disposed in a front portion of the electric snowmobile 10, and a straddle seat 22 is disposed above the tunnel 14 for accommodating an operator of the electric snowmobile 10 and optionally one or more passengers. Skis 18, namely left and right skis, may be movably attached to the frame 12 to permit steering of the electric snowmobile 10 via a steering assembly including a steering column 19 connected to a handle 20. Front suspensions 45 (shown in FIG. 4) are connected to the skis 18 and used to dampen movements of the snowmobile 10 when in use.

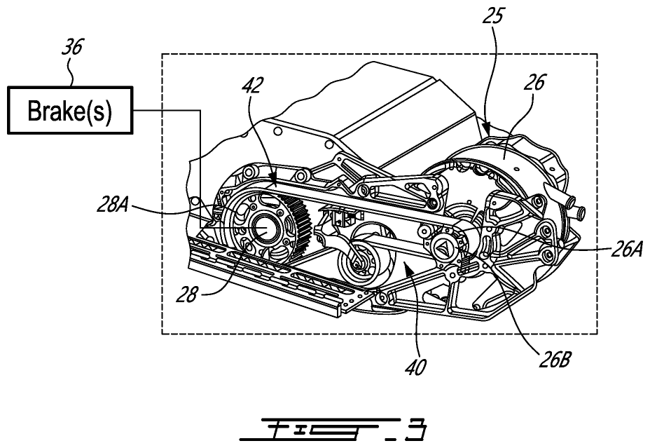

Referring to FIGS. 1 and 3, the powertrain 16 of the electric snowmobile 10 includes an electric motor assembly 25. The electric motor assembly 25 is a collection of components and features which function to deliver an electric drive to displace the electric snowmobile 10. The electric motor assembly 25 includes one or more electric motor(s) 26 drivingly coupled to the drive track 15 via a drive shaft 28. In one embodiment, the electric motor 26 has a maximum output power of between 120 and 180 horse power. In other embodiments, the electric motor 26 has a maximum output power of at least 180 horse power. The drive shaft 28 may be drivingly coupled to the drive track 15 via one or more toothed wheels or other means so as to transfer motive power from the electric motor 26 to the drive track 15. The powertrain 16 may also include a battery pack 30 for providing electric energy (i.e. electric current) to the electric motor 26 and driving the electric motor 26. The operation of the electric motor 26 and the delivery of drive current to the electric motor 26 from the battery pack 30 may be controlled by a controller 32 based on an actuation of an input device 34, sometimes referred to as a “throttle” or “accelerator”, by the operator. The controller 32 and the input device 34 are part of a control system CS for controlling operation of the electric snowmobile 10. In some embodiments, the battery pack 30 may be a lithium ion or other type of battery pack 30.

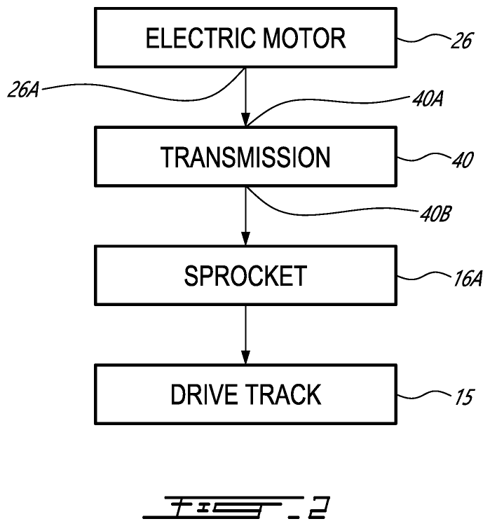

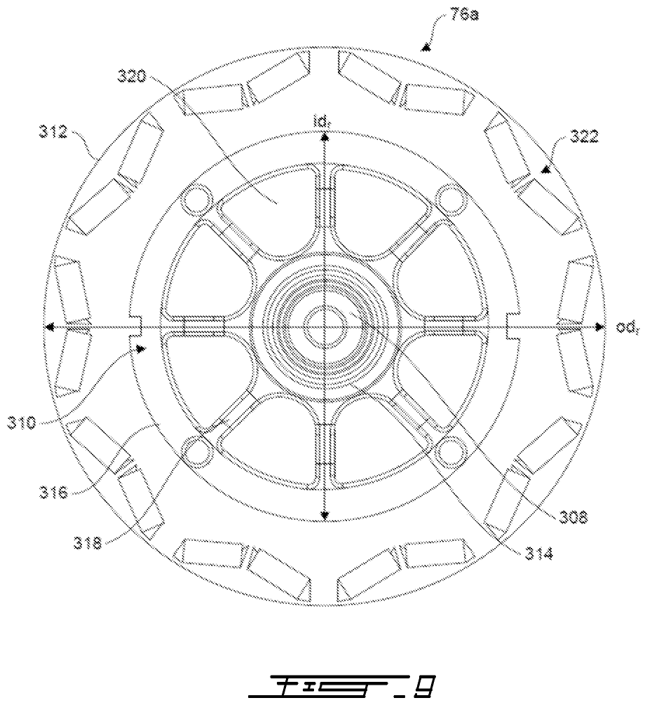

Referring now to FIG. 2, a schematic representation of a mechanical connection between the electric motor 26 and the drive track 15 is shown. The electric motor 26 is in driving engagement with the drive track 15 via a transmission 40. The transmission 40 has an input 40A drivingly engaged by a drive shaft, also referred to as a motor output 26A, of the electric motor 26. The transmission 40 further has an output 40B drivingly engaged to the input 40A. The output 40B of the transmission 40 drivingly engages a sprocket 16A (FIG. 8) of the powertrain 16, herein via the drive shaft 28. The drive shaft 28 may be coaxial with the sprocket 16A. The sprocket 16A is rotationally engaged to the frame 12 and meshed with the drive track 15. That is, the sprocket 16A may be mounted for rotation on the frame 12. The sprocket 16A may be secured to an axle drivingly engaged to the drive shaft 28. The axle may correspond to the drive shaft 28. The axle or drive shaft 28 may be rotationally supported on the frame 12 via bearings or any other suitable rotation means.

In the present embodiment, a rotational input provided by the electric motor 26 via its motor output 26A is transmitted to the drive track 15 via the transmission 40 and via the sprocket 16A. The transmission 40 may provide a speed ratio between the input 40A and the output 40B. In the present disclosure, the speed ratio of the transmission 40 is defined as a rotational speed of the input 40A to a rotational speed of the output 40B.

Referring to FIGS. 1 and 3, the electric snowmobile 10 may also include one or more brake(s) 36 (referred hereinafter in the singular) that may be applied or released by an actuation of a brake actuator (e.g., lever) 38 by the operator for example. The brake 36 may be operable as a main brake for the purpose of slowing and stopping the electric snowmobile 10 during motion of the electric snowmobile 10. The brake 36 may comprise a combination of tractive braking and regenerative braking. In some embodiments, the brake 36 may be operable as described in U.S. patent application Ser. No. 17/091,712 entitled “Braking system for an off-road vehicle”, the entirety of which is incorporated herein by reference. Alternatively or in addition, the brake 36 may be operable as a parking brake, sometimes called “e-brake” or “emergency brake”, of the electric snowmobile 10 intended to be used when the electric snowmobile 10 is stationary. In various embodiments, such main and parking brake functions may use separate brakes, or may use a common brake 36. In some embodiments of tractive braking, the brake actuator 38 may be lockable when the brake 36 is applied in order to use the brake 36 as a parking brake. The brake 36 may be electrically or hydraulically operated. For example, the brake 36 may include a master cylinder operatively coupled to a brake calliper that applies brake pads against a brake rotor that is coupled to the powertrain 16. In some embodiments, such brake rotor may be secured to and rotatable with the drive shaft 28. In some embodiments of regenerative braking shown in FIG. 1, the brake 36 is electrically connected to the battery pack 30. The brake 36 may be a regenerative brake 36, or apply regenerative braking, such that the brake 36 or components thereof are able to supply the battery pack 30 with electric energy when the brake 36 is applied to a component of the powertrain 16, and/or when the operator releases the input device 34 (e.g., accelerator).

Still referring to FIGS. 1 and 3, as explained above, the electric motor 26 is in torque-transmitting engagement with the drive shaft 28 via the transmission 40. In the present embodiment, the transmission 40 is of a belt/pulley type, but may alternatively be of a chain/sprocket type, a shaft/gear type, or a gear box for example. Referring to FIG. 3, the transmission 40 is of a belt/pulley type. The transmission 40 includes a drive belt 42 that is mounted about a driving wheel 26B drivingly engaged by the motor output 26A of the electric motor 26, and is also mounted about a driven wheel 28A engaged to the drive shaft 28. The drive belt 42 therefore extends between the driving wheel 26B and the driven wheel 28A for conveying torque from the electric motor 26 to the drive shaft 28 and to the drive track 15 via the sprocket 16A. The drive shaft 28 provides torque to the drive track 15. The drive belt 42 is thus displaced or driven by the motor output 26A in a linear manner between the driving wheel 26B and the driven wheel 28A, and in a circumferential manner about the driving wheel 26B and the driven wheel 28A.

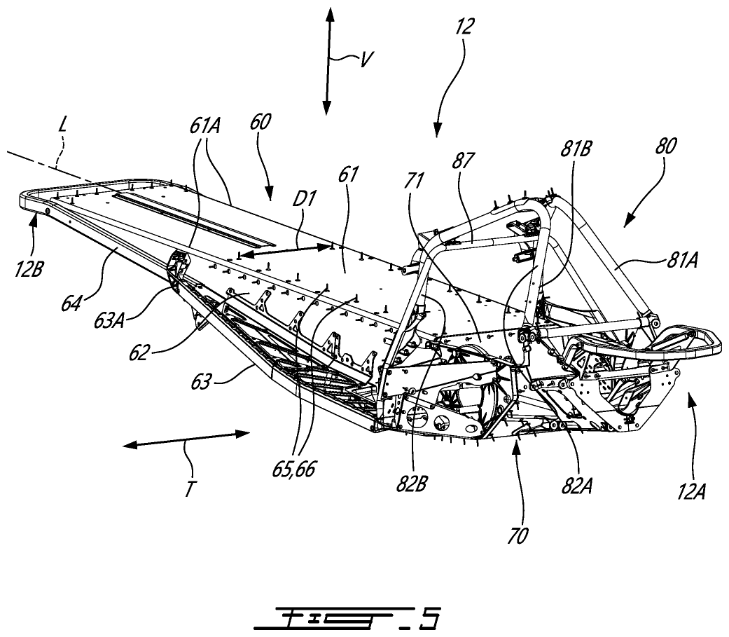

Referring now to FIGS. 4-5, the electric snowmobile 10 includes front suspensions 45 connected to the skis 18. Namely, each of the front suspensions 45 is connected to a respective one of the skis 18. The frame 12 of the electric snowmobile 10 extends along a longitudinal axis L between a front end 12A and a rear end 12B. The frame 12 includes a tunnel 60, a sub-frame 70, and a structure 80. The sub-frame 70 is disposed forward of the tunnel 60 relative to the longitudinal axis L. The sub-frame 70 may define a cavity or spacing that is sized for receiving the electric motor 26 and optionally, at least a portion of the transmission 40. The electric motor 26 may be secured (e.g., fastened) to the sub-frame 70. The tunnel 60 at least partially encloses a spacing receiving the drive track 15 (FIG. 1). The sub-frame 70 defines a bulkhead 71 that connects the sub-frame 70 to the tunnel 60. The structure 80 is disposed over the sub-frame 70. The structure 80 may be secured to the tunnel 60, to the sub-frame 70, and to the front suspensions 45. More specifically, and in the embodiment shown, the structure 80 is connected to the front suspension 45 and to the sub-frame 70 at the same location. Alternatively, the structure 80, which may include transverse member 87, is connected to the front suspension 45 via left and right front legs 81A, 82A, and to the sub-frame 70 via transverse member 87. The structure 80 is connected to the tunnel 60 via left and right rear legs 81B, 82B. Thus, loads are transferred from the skis 18 to the front suspensions 45 and from the front suspensions 45 to the structure 80, and from the structure 80 to the tunnel 60 and sub-frame 70. More detail about the structure 80 are presented in U.S. patent application No. 63/368,679 filed on Jul. 18, 2022, the entire contents of which are incorporated herein by reference.

Referring more particularly to FIG. 5, the tunnel 60 has a top panel 61 defining a substantially planar surface that faces upwardly in a vertical direction V. The expression “substantially” used in the context of the present disclosure is meant to encompass slight variations caused by manufacturing tolerances. The tunnel 60 includes two side panels 62 each extending downwardly from longitudinal edges 61A of the top panel 61. The two side panels 62 are therefore substantially transverse to the top panel 61 to partially enclose the spacing sized for receiving the drive track 15. The tunnel 60 may be a sheet bended to define the longitudinal edges 61A located at intersections between the top panel 61 and the two side panels 62. The tunnel 60 includes foot rests 63 (sometimes referred to as “running boards”), namely left and right foot rests each sized for receiving a foot of a user sitting on the straddle seat 22 (FIG. 1) of the electric snowmobile 10. The foot rests 63 may each extend transversally in a transverse direction T from a respective one of the two side panels 62. In the embodiment shown, the foot rests 63 are secured to bottom edges of the two side panels 62. The foot rests 63 extend longitudinally relative to the longitudinal axis L from the sub-frame 70 towards the rear end 12B of the frame 12.

Still referring to FIG. 5, in the embodiment shown, a peripheral beam 64 is secured to the tunnel 60 and extends from a rear end 63A of one of the foot rests 63, wraps around a rear portion of the tunnel 60 at the rear end 12B of the frame 12 and reaches the rear end 63A of the other of the foot rests 63. The peripheral beam 64 may be secured to the tunnel 50 adjacent the rear ends 63A of the foot rests 63 and at one or more locations along its length. The peripheral beam 64 may increase a stiffness of the tunnel 60. The peripheral beam 64 may provide a bumper at the rear end 12B of the frame 12.

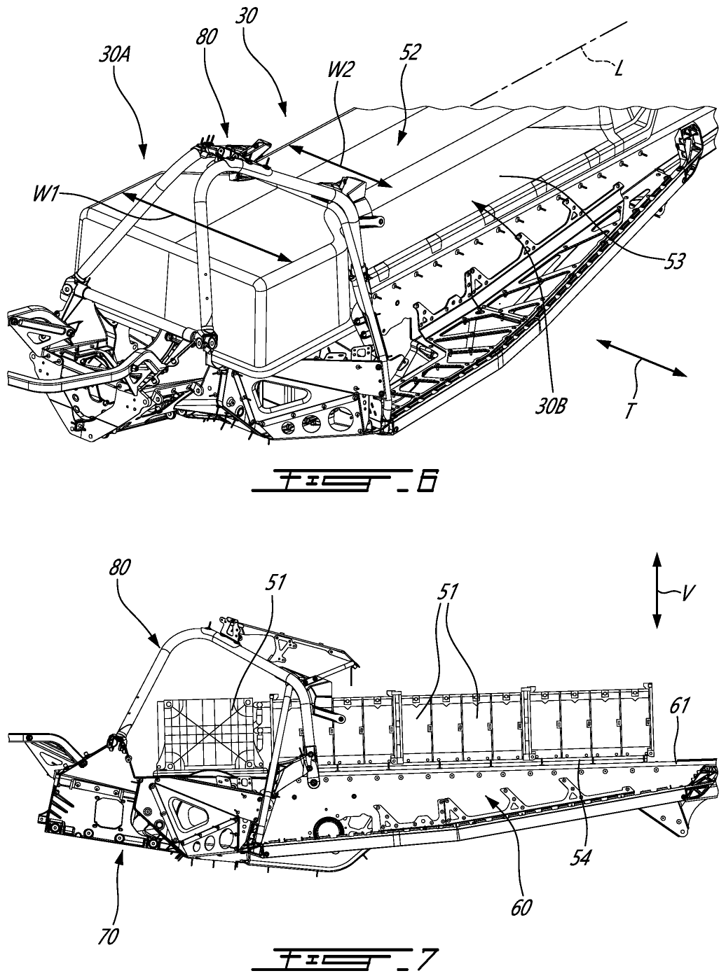

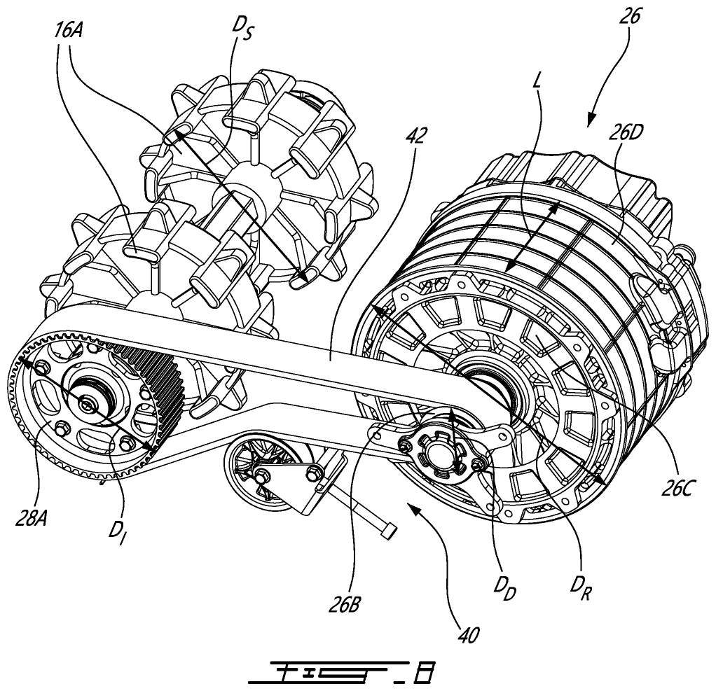

Referring now to FIGS. 6-7, the battery pack 30 is mounted to the frame 12 and disposed at least partially rearward of the electric motor 26 relative to the longitudinal axis L. The battery pack 30 includes one or more battery modules 51 operatively connected to the electric motor 26 for supplying electrical energy to the electric motor 26. The battery pack 30 further includes a battery enclosure 52 containing the one or more battery modules 51. In the embodiment shown, the battery pack 30 has a front portion 30A and a rear portion 30B located rearward of the front portion 30A relative to the longitudinal axis L. A width W1 of the front portion relative to the transverse direction T normal to the longitudinal axis L is greater than a width W2 of the rear portion 30B. The structure 80 is designed to accommodate this battery pack 30. The rear portion 30B of the battery pack 30 is disposed above the tunnel 60. More specifically, the rear portion 30B of the battery pack 30 is secured (e.g., glued, fastened) to the top panel 61 of the tunnel 60. The front portion 30A is disposed over the sub-frame 70 and at least partially overlaps the electric motor 26 and optionally, at least a portion of the transmission 40.

The battery enclosure 52 includes a cover 53 and a bottom panel 54. The cover 53 may be removably secured to the bottom panel 54. In other words, the cover 53 may be removed from the bottom panel 54 to access the battery modules 51 and/or other components of the battery pack 30 for maintenance purposes. The battery pack 30 may be secured to the tunnel 60 via the bottom panel 54 of the battery enclosure 52. In a further embodiment, the battery pack 30 may be secured to the tunnel 60 via a combination of the bottom panel 54 and the cover 53 of the battery enclosure 52. The battery modules 51 may be supported by the bottom panel 54 and secured thereto using any suitable techniques.

Designing an electric off-road powersport vehicle requires a compromise between packaging size and performance. The packaging may be limited in size due to the nature of straddle seat vehicles, while torque and maximum speed need to meet appropriate performance thresholds comparable to those of combustion engine powersport vehicles. For the electric motor 26, a size of the rotor has more impact on the motor's performance than a size of the stator. If the rotor is small, the attainable torque is limited and to provide the powersport vehicle with desired torque performance, requires that a size of the sprocket (e.g. drive sprocket 16A) also be small. However, while a small rotor and sprocket size may provide the desired torque and easy packaging, it will result in a lower maximum speed. In contrast, if the sprocket is too big, a higher maximum speed is attainable, but at the expense of a lower torque. By increasing a rotor size of the motor, more torque becomes available, and a larger sprocket may be used to achieve desired torque and a higher maximum speed, but packaging both a larger rotor and sprocket within the straddle seat vehicle can present challenges. Another variable that could impact the relationship between the sizes of the rotor and drive sprocket is a transmission ratio between the drive shaft and the driven shaft. Although packaging a transmission to achieve both a desired torque and maximum speed also presents challenges.

For off-road powersport vehicles, achieving both relatively high torque and relatively high maximum speed are required to provide a rider with an expected riding experience. While combustion engine vehicles are able to achieve these performance characteristics relatively easily due to the nature of combustion engines and the use of continuously variable transmissions (CVTs), for electric vehicles, more complex packaging considerations are required to achieve similar torque and speed requirements while being able to package a suitable electric motor, drive sprocket and battery pack on a frame of a saddle-seat vehicle.

More specifically, off-road powersport vehicles differ from on-road automotive vehicles (e.g. cars, trucks and motorcycles) both in terms of the way they are driven and the performance expectations of their riders. Electric drive units for on-road automotive vehicles are designed to operate well below their maximum power capability during typical driving conditions (such as during city driving and/or highway driving). In contrast, according to one aspect of the present disclosure, off-road powersport vehicles are designed to operate fairly continuously at, or near, their maximum power capability. These powersport vehicles may provide an improved rider experience by enabling extended operation at high speeds and/or high torque values. For example, high torque may be useful in some off-road environments where a powersport vehicle might be prone to getting stuck (e.g., in deep snow). In some embodiments, electric drive units are designed and configured to address these challenges by providing a high efficiency at a maximum power capability. Because electric drive units for on-road automotive vehicles are rarely operated at their maximum power capability, high efficiency at maximum power is typically not a concern for the electric drive units of on-road automotive vehicles.

In addition to providing high power at high motor efficiencies, electric drive units for powersport vehicles are designed to be relatively small to permit accommodation within the limited space available within the powersport vehicle. Electric drive units for powersport vehicles are also designed to be relatively light weight to maintain battery range-efficiency for the vehicle. The heavier the drive unit, the more energy (i.e., battery capacity) is required to achieve a desirable range.

The electric snowmobile 10 requires a battery pack of substantial size to provide a desired speed and range. In the present embodiment, the battery pack 30 is sized to extend over the tunnel 60 and to at least partially overlap the sub-frame 70 and the electric motor 26, and optionally, at least a portion of the transmission 40. Consequently, the available space for the electric motor 26 and transmission 40 is limited. In some embodiments, a size of the electric motor 26 may be constrained by the available space defined by the sub-frame 70 and below the front section 30A of the battery pack 30. Moreover, for maneuverability reasons, even if the battery pack 30 were smaller, the electric motor 26 would still be located towards the front end 12A of the frame 12 to facilitate appropriate location of the center of gravity of the snowmobile 10. Thus, the battery pack 30 may remain over the electric motor 26 and at least a portion of the transmission 40. For a given size of the electric motor 26, which is limited by the space constraints as explained above, the transmission 40 has to be able to convert the rotational input of the electric motor 26 to provide the drive track 15 with appropriate torque and speed so that the electric snowmobile 10 has the desired acceleration and maximum speed. In one example, it may be desired to obtain a maximum speed of the electric motor 26 of about from 8000 to 9000 RPM, a maximum power of between 90-160 kW, and a maximum torque of the electric motor 26 of about between 150-200 Nm.

Referring now to FIG. 8, in the embodiment shown, these characteristics of the snowmobile 10 may be achieved by applying appropriate relative dimensions of the different components of the transmission 40 and power train 16. These different dimensions include a rotor diameter D_{R} of a rotor 26C of the electric motor 26, a sprocket diameter D_{S} of the sprocket 16A that is meshed with the drive track 15, a length L of a stator 26D or rotor 26C of the electric motor 26, a drive diameter D_{D} of the driving wheel 26B drivingly engaged by the motor output 26A, and a driven diameter D_{I} of the driven wheel 28A that is drivingly engaged to the driving wheel 26B via the drive belt 42. The length of the stator 26D may be equal to a length of the rotor 26C. In some embodiments, the transmission 40 may include a gearbox or any suitable transmission means. In such a case, a speed ratio of the transmission 40 expressed as a rotational speed of the input 40A (FIG. 2) to a rotational speed of the output 40B (FIG. 2) may be used. This speed ratio may alternatively be defined as a ratio of the driven diameter D_{I} to the drive diameter D_{D}.

In the embodiment shown, the electric snowmobile 10 has one or more of: a rotor-to-sprocket ratio of the rotor diameter D_{R} to the sprocket diameter D_{S} ranging from 0.65 to 1.30; a rotor-to-transmission ratio of the rotor diameter D_{R} to the speed ratio of the transmission 40 ranging from 52 mm to 180 mm; a stator-to-sprocket ratio of the length L of the stator 26D to the sprocket diameter D_{S} ranging from 0.20 to 0.58; a rotor size-to-sprocket ratio of a product of the rotor diameter D_{R} by the length L of the stator 26D to the sprocket diameter D_{S} ranging from 25 mm to 105 mm; and a rotor-to-driven-and-sprocket ratio of the rotor diameter D_{R} divided by a ratio of the driven diameter D_{I} to the sprocket diameter D_{S} ranging from 166 mm to 231 mm. In the present embodiment, the rotor size is represented by the product of the rotor diameter D_{R} by the length L of the stator 26D. Alternatively, a volume of the rotor may be used. However, the rotor size used herein may be more representative of the size of the parts of the electric motor 26 that generate torque. Put differently, the inner diameter of the rotor may be substantially hollow; the outer diameter and length are what contribute electromagnetically to torque generation. A hub and shaft of the electric motor 26 do not contribute to torque production.

Any combinations of two, or more than two, of those ratios are contemplated. For instance, the electric snowmobile 10 may have the rotor-to-sprocket ratio ranging from 0.65 to 1.30 and the rotor-to-transmission ratio ranging from 52 mm to 180 mm. The electric snowmobile 10 may have the rotor-to-sprocket ratio ranging from 0.65 to 1.30 and the stator-to-sprocket ratio ranging from 0.20 to 0.58. The electric snowmobile 10 may have the rotor-to-sprocket ratio ranging from 0.65 to 1.30 and the rotor size-to-sprocket ratio ranging from 25 mm to 105 mm. The electric snowmobile 10 may have the rotor-to-sprocket ratio ranging from 0.65 to 1.30 and the rotor-to-driven-and-sprocket ratio ranging from 166 mm to 231 mmm. The electric snowmobile 10 may have the rotor-to-transmission ratio ranging from 52 mm to 180 mm and the stator-to-sprocket ratio ranging from 0.20 to 0.58. The electric snowmobile 10 may have the rotor-to-transmission ratio ranging from 52 mm to 180 mm and the rotor size-to-sprocket ratio ranging from 25 mm to 105 mm. The electric snowmobile 10 may have the rotor-to-transmission ratio ranging from 52 mm to 180 mm and the rotor-to-driven-and-sprocket ratio ranging from 166 mm to 231 mm. The electric snowmobile 10 may have the stator-to-sprocket ratio ranging from 0.20 to 0.58 and the rotor size-to-sprocket ratio ranging from 25 mm to 105 mm. The electric snowmobile 10 may have the stator-to-sprocket ratio ranging from 0.20 to 0.58 and the rotor-to-driven-and-sprocket ratio ranging from 166 mm to 231 mm. The electric snowmobile 10 may have the rotor size-to-sprocket ratio ranging from 25 mm to 105 mm and the rotor-to-driven-and-sprocket ratio ranging from 166 mm to 231 mm.

In some embodiments, the electric snowmobile 10 may have an overall value of the rotor diameter D_{R} multiplied by the speed ratio of the transmission 40 multiplied by the sprocket diameter D_{S} of the sprocket 16A ranging from about 17940 mm² to about 90000 mm². The overall value may be preferably about 68982. This overall value may be combined with one or more of any of the ratios described above, that include, the rotor-to-sprocket ratio, the rotor-to-transmission ratio, the stator-to-sprocket ratio, the rotor size-to-sprocket ratio, and the rotor-to-driven-and-sprocket ratio.

In some embodiments, the rotor-to-sprocket ratio ranges from 0.70 to 1.23 and is preferably about 0.85. In some embodiments, the rotor-to-transmission ratio ranging from 56 to 170 and is preferably about 66. In some embodiments, the stator-to-sprocket ratio ranges from 0.23 to 0.51 and is preferably about 0.30. In some embodiments, the rotor size-to-sprocket ratio ranging from 31 mm to 87 mm and is preferably about 46 mm. In some embodiments, the rotor-to-driven-and-sprocket ratio ranging from 179 mm to 218 mm and is preferably about 201 mm. In some embodiments, the speed ratio is about 2.375. The speed ratio may correspond to a number of teeth of the driven wheel 28A to a number of teeth of the driving wheel 26B. In one example, the driven wheel 28A may have 57 teeth and the driving wheel 26B may have 24 teeth.

In a non-limiting example, the rotor may have a diameter of from 130 mm to 180 mm, preferably from 140 mm to 170 mm, preferably from 150 mm to 160 mm, preferably 157 mm; the sprocket may have a diameter of from 138 mm to 200 mm, preferably 150 mm to 195 mm, preferably 160 mm to 190 mm, preferably approximately 185 mm; the driven wheel may have a diameter of from 130 mm to 160 mm, preferably 140 mm to 150 mm, preferably approximately 145 mm; the driving wheel may have a diameter of approximately 61 mm; the length of the stator or rotor may range from 40 mm to 80 mm, preferably from 45 mm to 70 mm, preferably 50 mm to 60 mm, preferably approximately 55 mm; a belt ratio defined as a diameter of the driven wheel to a diameter of the drive wheel may range from 1 to 2.5, preferably approximately 2.375; a ratio of the diameter of the driven wheel to the diameter of the sprocket may range from 0.65 to 1.15, preferably 0.7 to 1, preferably approximately 0.78.

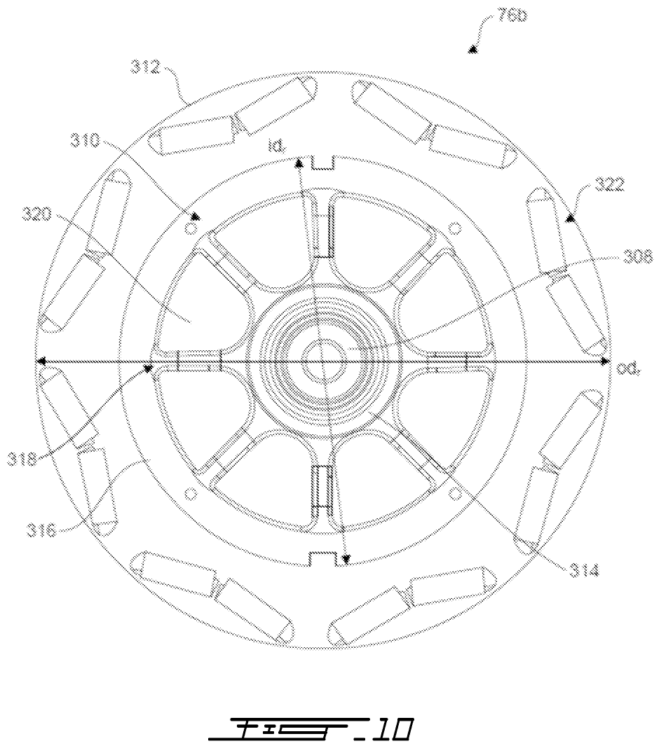

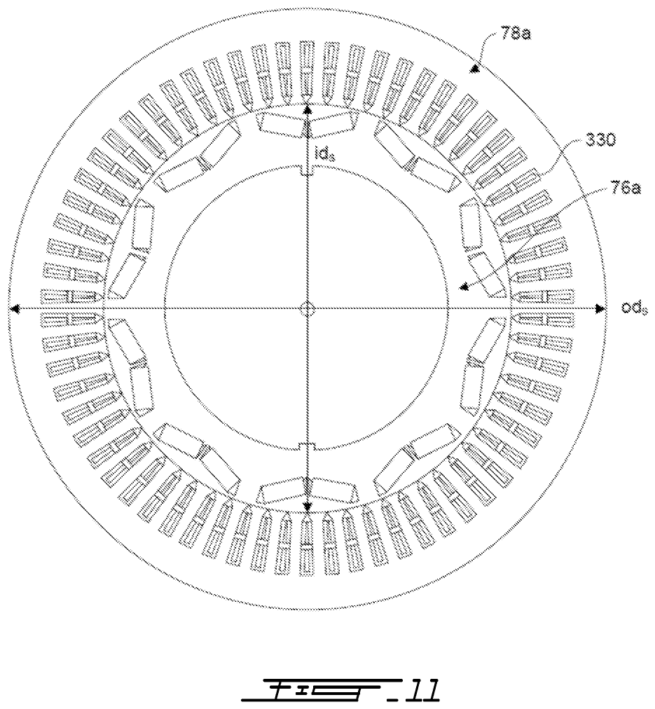

FIG. 9 is a front plan view of a rotor 76a, and FIG. 10 is a front plan view of a rotor 76b, according to examples of the present disclosure. These rotors 76a, 76b may be used as the rotor 26C of the electric motor 26 described above with reference to FIG. 3. FIGS. 9 and 10 provide two different examples of rotors 76a, 76b. Like components will be described using like reference numbers for both rotors 76a, 76b. Rotors 76a, 76b each comprise a rotor shaft 308, a hub 310 and a rotor laminate 312 located radially outward from the hub 310, such that the hub is positioned between the rotor shaft 308 and the rotor laminate 312. The hub 310 may comprise a material that is less dense than the rotor laminate 312. In one example, the hub 310 may be made of aluminum. In one example, the hub 310 may comprise an inner hub 314 surrounding the rotor shaft 308, an outer hub 316 in communication with the rotor laminate 312 and spokes 318 extending between the inner hub 314 and the outer hub 316, creating void regions 320 of no material between circumferentially adjacent spokes 318. The less dense material of the hub 310 and the void regions 320 of no material, create weight efficiencies which improve power density for the drive unit 30.

The rotor laminate 312 may comprise a steel material, such as silicon steel, or nickel-iron steel, among other possibilities. An inner diameter idᵣ of the rotor laminate 312 may be greater than 90 mm. In some examples, the inner diameter idᵣ may be between 90-120 mm. In some examples, the inner diameter idᵣ may be between 105-115 mm. An outer diameter odᵣ of the rotor laminate 312 may be less than 180 mm. In some examples, the outer diameter odᵣ of the rotor laminate 312 may be between 140-170 mm, and preferably between 150-165 mm. In some examples, the outer diameter odᵣ of the rotor laminate 312 may be between 155-160 mm. An axial length of the rotor may be in the order of 45-65 mm, and in some examples in the order of 50-60 mm.

Embedded within the rotor laminate 312 are magnets 322. In one example, pairs of the magnets 322 are positioned in a V-shape. The V-shape of magnets 322 provides increased flux and thus increased power to the drive unit 30 compared to magnets positioned in a straight arrangement and spanning the same circumference of the rotor laminate 312. More specifically, the V-shape magnets provide a greater magnet surface area than a straight magnet occupying the same rotor surface (i.e. two sides of a triangle as opposed to one straight side). The V-shape topology also provides higher dq inductances which provide more torque and wider speed range than a rotor with a straight magnet occupying the same rotor surface.

With reference to FIG. 9, the magnets 322 of rotor 76a comprise 10 poles. With reference to FIG. 10, the magnets 322 of rotor 76b comprise 8 poles. The magnets 322 of rotor 76b are larger than the magnets of rotor 76a. The magnets 322 of rotor 76b may comprise a volume of greater than 7000 mm3, and in some examples greater than 7500 mm3. In one example, the magnets 322 of rotor 76b have a volume between 7300 mm3 and 7600 mm3. In contrast, the magnets 322 of rotor 76a may have a volume between 6400 mm3-6700 mm3. The use of larger magnets with a reduced number of poles may reduce the core losses in comparison to a rotor having smaller magnets and a larger number of poles.

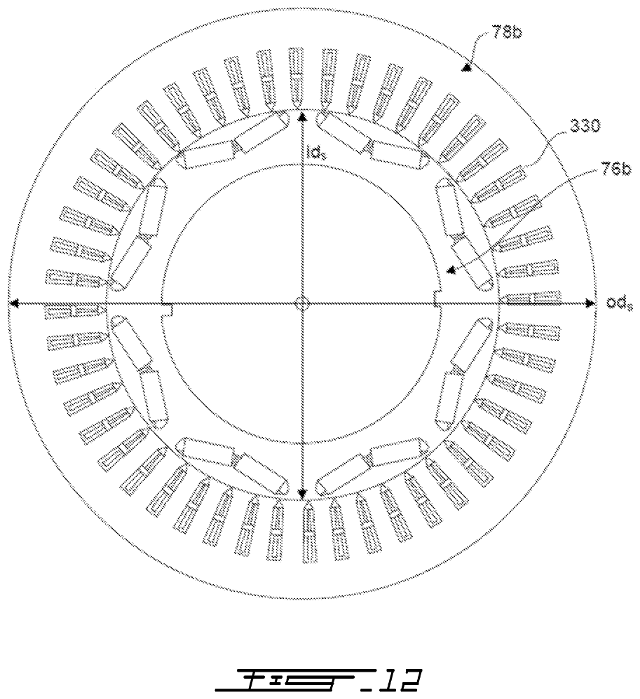

FIG. 11 is a front plan view of rotor 76a and a stator 78a, and FIG. 12 is a front plan view of rotor 76b and a stator 78b, according to examples of the present disclosure. With reference to FIG. 11, rotor 76a is shown together with a corresponding stator 78a. Stator 78a comprises sixty six (66) slots 330 with a double layer asymmetric winding pattern having one turn per coil. With reference to FIG. 12, rotor 76b is shown together with a corresponding stator 78b. Stator 78b comprises forty eight (48) slots 330 with a single layer symmetric winding pattern having four parallel paths (coils) with three turns per coil, which is more practical for automated mass-manufacturing. Furthermore, a winding pattern having three turns per coil provides an increased inductance compared to a winding pattern having less turns per coil. The increased inductance provides a smoother current supply making the drive unit easier to control while limiting the power via a voltage limit.

The stators 78a and 78b may have an inner diameter idₛ greater than 150 mm. In some examples, the inner diameter idₛ may be between 150-170 mm. In some examples, the inner diameter idₛ may be between 155-160 mm. An outer diameter od s of the stator 78a, 78b may be less than 250 mm. In some examples, the outer diameter od s may be between 230 mm-250 mm. In some examples, the outer diameter od s of the stator 78a, 78b may be between 230-240 mm. An air gap between the outer diameter odᵣ of the rotor 76a, 76b and the inner diameter idₛ of the stator 78a, 78b may be approximately 0.5 mm-1 mm.

Although not shown, in one example, either rotor 76a or rotor 76b may provide a rotor skew where the rotor is divided into slices along its axial length, with each slice being shifted in relation to the other slices. In one example, rotor 76a, 76b may be divided into three slices with each slice shifted (e.g. rotated) by approximately 2-4 degrees in relation to an adjacent slice. In some embodiments, the rotor 76a, 76b may be divided into more or less slices, with each slice shifted by between 1.5 and 4 degrees in relation to an adjacent slide. Providing a rotor skew may reduce cogging torques which may reduce the instant forces required to start rotating the rotor. In the case of powersport vehicles such as snowmobiles where a rider may be required to push the vehicle out of a snowbank or snowdrift, having reduced cogging torques may facilitate pushing the vehicle from a stopped state and may reduce the level of vibration and acoustic noise of the powertrain.

Therefore, a snowmobile characterized by any combinations of the above ratios may provide a transmission 40 and electric motor 26 able to fit in the available space while providing the required maximum speed and required torque.

In the context of the present disclosure, the expression “about” or “approximately” implies variations of plus or minus 10%.

The embodiments described in this document provide non-limiting examples of possible implementations of the present technology. Upon review of the present disclosure, a person of ordinary skill in the art will recognize that changes may be made to the embodiments described herein without departing from the scope of the present technology. Yet further modifications could be implemented by a person of ordinary skill in the art in view of the present disclosure, which modifications would be within the scope of the present technology.

1. An electric snowmobile, comprising:
a frame extending along a longitudinal axis between a front end and a rear end of the frame;
a drive track assembly having a drive track for engaging a ground and a sprocket rotationally engaged to the frame and meshed with the drive track;
an electric motor mounted to the frame; and
a transmission mounted to the frame, the transmission drivingly engaging the electric motor to the drive track, the transmission having an input drivingly engaged by the electric motor and an output drivingly engaging the sprocket, the transmission having a speed ratio defined as a rotational speed of the input to a rotational speed of the output, and
wherein one or more of:
a rotor-to-sprocket ratio of a rotor diameter of a rotor of the electric motor to a sprocket diameter of the sprocket ranges from 0.65 to 1.30,
a rotor-to-transmission ratio of the rotor diameter to the speed ratio of the transmission ranges from 52 mm to 180 mm,
a stator-to-sprocket ratio of a length of a stator of the electric motor to the sprocket diameter ranges from 0.20 to 0.58, and
a rotor size-to-sprocket ratio of a product of the rotor diameter by the length of the stator to the sprocket diameter ranges from 25 mm to 105 mm.

2. The electric snowmobile of claim 1, wherein the rotor-to-sprocket ratio ranges from 0.65 to 1.30 and the rotor-to-transmission ratio ranges from 52 mm to 180 mm.

3. The electric snowmobile of claim 1, wherein the rotor-to-sprocket ratio ranges from 0.65 to 1.30 and the stator-to-sprocket ratio ranges from 0.20 to 0.58.

4. The electric snowmobile of claim 1, wherein the rotor-to-sprocket ratio ranges from 0.65 to 1.30 and the rotor size-to-sprocket ratio ranges from 25 mm to 105 mm.

5. The electric snowmobile of claim 1, wherein the rotor-to-transmission ratio ranges from 52 mm to 180 mm and the stator-to-sprocket ratio ranges from 0.20 to 0.58.

6. The electric snowmobile of claim 1, wherein the rotor-to-transmission ratio ranges from 52 mm to 180 mm and the rotor size-to-sprocket ratio ranges from 25 mm to 105 mm.

7. The electric snowmobile of claim 1, wherein the stator-to-sprocket ratio ranges from 0.20 to 0.58 and the rotor size-to-sprocket ratio ranges from 25 mm to 105 mm.

8. The electric snowmobile of claim 1, wherein the rotor-to-sprocket ratio ranges from 0.70 to 1.23.

9. The electric snowmobile of claim 8, wherein the rotor-to-sprocket ratio is about 0.85.

10. The electric snowmobile of claim 1, wherein the rotor-to-transmission ratio ranges from 56 to 170.

11. The electric snowmobile of claim 10, wherein the rotor-to-transmission ratio is about 66.

12. The electric snowmobile of claim 1, wherein the stator-to-sprocket ratio ranges from 0.23 to 0.51.

13. The electric snowmobile of claim 12, wherein the stator-to-sprocket ratio is about 0.30.

14. The electric snowmobile of claim 1, wherein the rotor size-to-sprocket ratio ranges from 31 mm to 87 mm.

15. The electric snowmobile of claim 14, wherein the rotor size-to-sprocket ratio is about 46 mm.

16. The electric snowmobile of claim 1, wherein the speed ratio is about 2.375.

17. The electric snowmobile of claim 1, wherein the frame includes a sub-frame and a tunnel secured to the sub-frame, the electric motor mounted to the sub-frame, a battery pack extending over the tunnel and at least partially overlapping the electric motor.

18. The electric snowmobile of claim 17, wherein the battery pack at least partially overlaps the transmission.

19. An electric snowmobile, comprising:
a frame extending along a longitudinal axis between a front end and a rear end of the frame;
a drive track assembly having a drive track for engaging a ground and a sprocket rotationally engaged to the frame and meshed with the drive track;
an electric motor mounted to the frame; and
a transmission mounted to the frame, the transmission drivingly engaging the electric motor to the drive track, the transmission having a drive wheel engaged to the electric motor and a driven wheel engaged to the drive wheel and engaging the sprocket, the transmission having a speed ratio defined as a driven diameter of the driven wheel to a drive diameter of the drive wheel, and
wherein one or more of:
a rotor-to-sprocket ratio of a rotor diameter of a rotor of the electric motor to a sprocket diameter of the sprocket ranges from 0.65 to 1.30,
a rotor-to-transmission ratio of the rotor diameter to the speed ratio of the transmission ranges from 52 mm to 180 mm,
a stator-to-sprocket ratio of a length of a stator of the electric motor to the sprocket diameter ranges from 0.20 to 0.58,
a rotor size-to-sprocket ratio of a volume of the rotor to the sprocket diameter ranges from 25 mm to 105 mm, and
a rotor-to-driven-and-sprocket ratio of the rotor diameter divided by a ratio of the driven diameter to the sprocket diameter ranges from 166 mm to 231 mm.

20. An electric snowmobile, comprising:
a frame extending along a longitudinal axis between a front end and a rear end of the frame;
a drive track assembly having a drive track for engaging a ground and a sprocket rollingly engaged to the frame and meshed with the drive track;
an electric motor mounted to the frame; and
a transmission mounted to the frame, the transmission drivingly engaging the electric motor to the drive track, the transmission having an input drivingly engaged by the electric motor and an output drivingly engaging the sprocket, the transmission having a speed ratio defined as a rotational speed of the input to a rotational speed of the output, and
wherein an overall value of a rotor diameter of a rotor of the electric motor multiplied by the speed ratio of the transmission multiplied by a sprocket diameter of the sprocket ranges from 17940 to 90000 mm².
